(19) United States
(12) Patent Application Publication
(10) Pub. No.: US 2009/0112396 A1
(43) Pub. Date: Apr. 30, 2009

(54) AUTOMOBILE SERVICING METHOD, DIAGNOSTIC SERVER AND AUTOMOBILE THEREOF

(75) Inventors: Shu-Jen Tsai, Tu-Cheng (TW); Long-Fong Chen, Tu-Cheng (TW); Wen-Haw Tseng, Tu-Cheng (TW); Shih-Fang Wong, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/247,995

(22) Filed: Oct. 8, 2008

(30) Foreign Application Priority Data
Oct. 29, 2007 (CN) 200710202295.0

(51) Int. Cl. G01M 17/00; G06F 17/30

(52) U.S. Cl. 701/33; 707/104.1; 707/E17.044

(57) ABSTRACT

An exemplary automobile servicing method includes: registering basic information of automobiles and service stations; receiving a self-check report, positional coordinates of one of the automobiles; analyzing the self-check report to generate diagnostic results of the automobile; selecting a desirable one of the service stations capable of performing a preventive maintenance or repair of the automobile according to the diagnostic results and the positional coordinates of the automobile; searching and transmitting prices of each item of the diagnostic results and positional coordinates of the desirable service station to the automobile, for one or more of the items being selected to generate a service order; receiving and transmitting the service order to the desirable service station, for informing the desirable service station to prepare for performing the preventive maintenance or repair of the automobile according to the service order. An exemplary related automobile and diagnostic server are also provided.

### BACKGROUND

1. Field of the Invention

The present invention relates to an automobile servicing method, a diagnostic server utilizing the automobile servicing method and an automobile.

2. Description of Related Art

Many people travel by automobiles. However, unless the automobile breaks down, most people would not know that something is wrong with their automobile. Although most automobiles are fitted with a self-checking system that performs a self-check and generate a self-check report, however, these self-checks are minimal checks and few people understands or are able to interpret these reports. Thus not many people would be aware that their automobile needs to be serviced and or which part needs to be replaced based on the self-check report. When the automobile breaks down while traveling, the journey has to be interrupted. As a result, time is wasted.

Therefore, a heretofore unaddressed need exists in the industry to overcome the aforementioned deficiencies and inadequacies.

### SUMMARY

A exemplary automobile servicing method includes: registering basic information of automobiles and service stations and assigning a unique identifier to each of the automobiles; receiving a combined data transmitted by one of the automobiles and parsing the combined data into a diagnostic request, a self-check report, positional coordinates and the unique identifier of the automobile; analyzing the self-check report to generate diagnostic results of the automobile in response to the diagnostic request on condition that the unique identifier being validated; selecting a desirable one of the service stations capable of performing a preventive maintenance or repair of the automobile according to the diagnostic results and the positional coordinates of the automobile; searching a price list of the desirable service station for prices of each item of the diagnostic results and the positional coordinates of the desirable service station; combining the prices of each item of the diagnostic results and the positional coordinates of the desirable service station to form an estimate report; transmitting the estimate report to the automobile, for one or more of the items of the diagnostic results being selected to generate a service order; receiving the service order transmitted by the automobile; and transmitting the service order to the desirable service station, for informing the desirable service station to prepare for performing the preventive maintenance or repair of the automobile according to the service order. An exemplary automobile and diagnostic server are also provided.

Other advantages and novel features of the present invention will become more apparent from the following detailed description of an embodiment/embodiments when taken in conjunction with the accompanying drawings.

### BRIEF DESCRIPTION OF THE DRAWINGS

FIG. 1 is a schematic diagram of a hardware infrastructure of a vehicle servicing system in accordance with an exemplary embodiment, and the vehicle servicing system including a plurality of automobiles, a diagnostic server, and a plurality of service stations.

FIG. 2 is a preprocessing flowchart of the automobile of FIG. 1 for requesting the diagnostic server that a diagnostic service is needed.

FIG. 3 a vehicle servicing flowchart of an exemplary method used by the diagnostic server 20 of FIG. 1.

FIG. 4 is an authorizing flowchart of an exemplary method used by the automobile of FIG. 1.

FIG. 5 is a schematic block diagram of the automobile of FIG. 1.

FIG. 6 is a schematic block diagram of the diagnostic server of FIG. 1.

### DETAILED DESCRIPTION

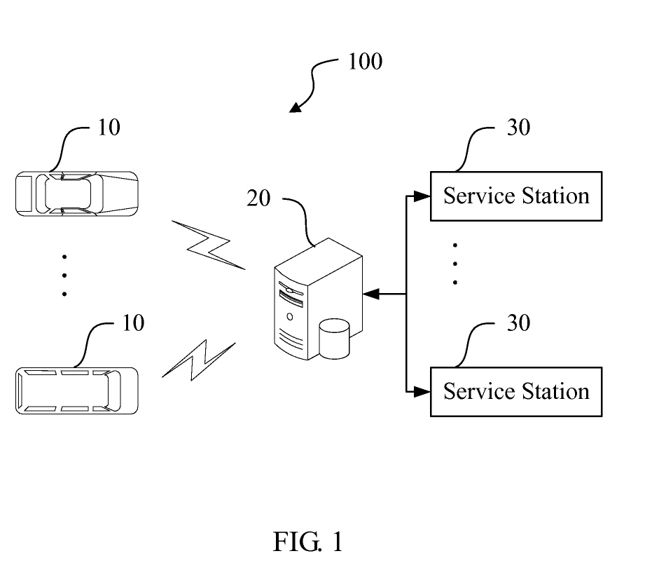

Referring to FIG. 1, a vehicle servicing system 100 in accordance with an exemplary embodiment is provided. The vehicle servicing system 100 includes automobiles 10, a diagnostic server 20, and service stations 30. The diagnostic server 20 registers basic information of the automobiles 10, and assigns a unique identifier to each of the automobiles 10 for identifying purposes. The diagnostic server 20 further registers basic information of the service stations 30 including a price list, positional coordinates, etc. The price list of the service station 30 lists the prices of each maintenance item and each repair item. The diagnostic server 20 provides diagnostic services for the automobiles 10, and if needed, selects one of the service stations 30 to perform a preventive maintenance or repair of the automobiles 10.

The basic information of the automobiles 10 include vehicle registration numbers, vehicle identification numbers (VINs), etc. The vehicle registration numbers are displayed on license plates that are commonly issued and administered by the government. The vehicle identification number is a unique serial number used by the automotive industry to identify individual motor vehicles and is a standardized 17 character number.

To more clearly describe the embodiment, only one automobile 10 and one service station 30 will be introduced. The automobile 10 communicates with the diagnostic server 20 via a wireless network. The diagnostic server 20 communicates with the service station 30 via the wireless network or a wired network.

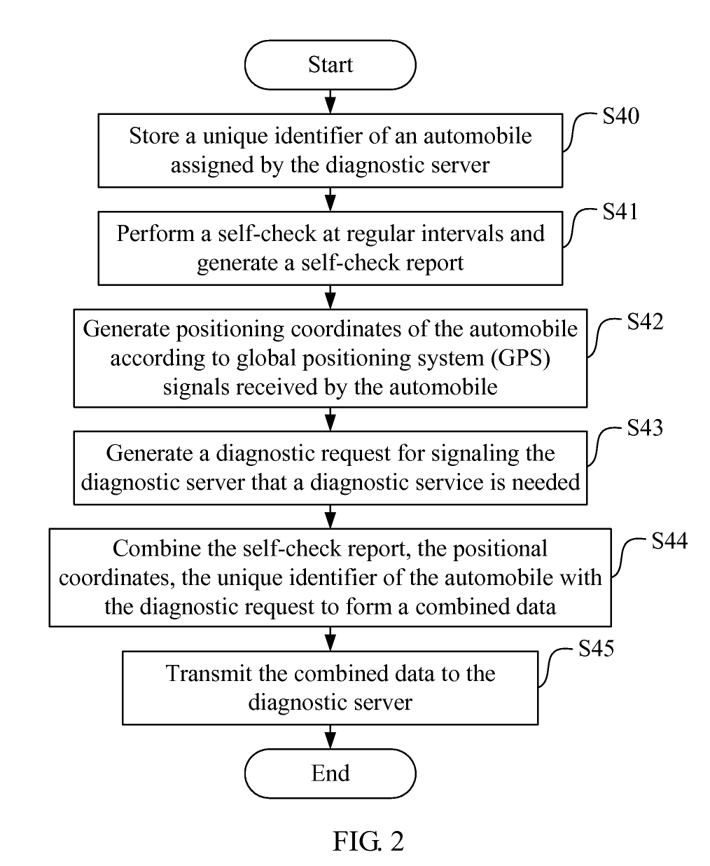

FIG. 2 is a preprocessing flowchart, of the automobile 10 of FIG. 1, for requesting to the diagnostic server 20 that diagnostic service is needed. In step S40, the automobile 10 stores the unique identifier thereof assigned by the diagnostic server 20.

In step S41, the automobile 10 performs the self-check at regular intervals and generates the self-check report.

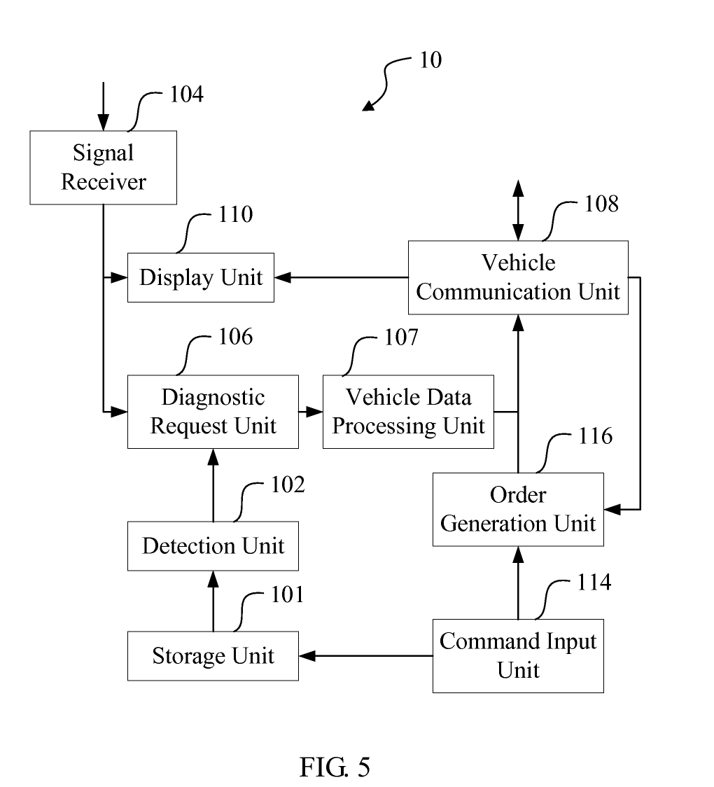

In step S42, and also referring to FIG. 5, a signal receiver 104 of the automobile 10 receives global positional system (GPS) signals, and generates positional coordinates of the automobile 10 according to the GPS signals.

In step S43, the automobile 10 generates a diagnostic request for signaling the diagnostic server 20 that the diagnostic service is needed.

In step S44, the automobile 10 reads the unique identifier, and combines the self-check report, the positional coordinates, and the unique identifier with the diagnostic request to form a combined data.

In step S45, the automobile 10 wirelessly transmits the combined data to the diagnostic server 20.

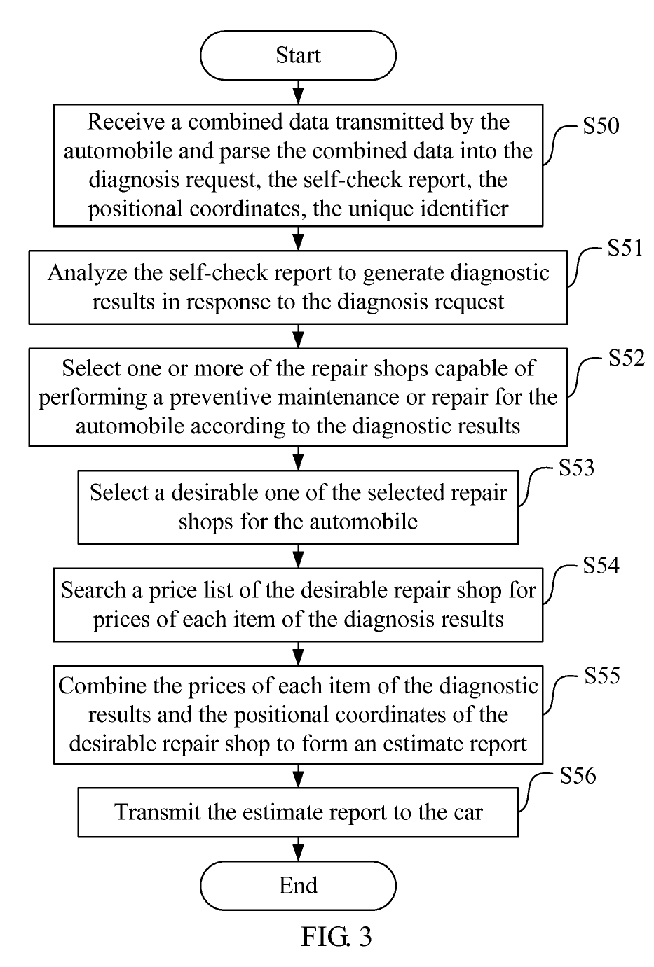

FIG. 3 is a vehicle servicing flowchart of an exemplary method used by the diagnostic server 20 of FIG. 1. In step S50, the diagnostic server 20 wirelessly receives the combined data transmitted by the automobile 10, and parses the combined data into the diagnostic request, the self-check report, the positional coordinates, and the unique identifier of the automobile 10.

In step S51, the diagnostic server 20 analyzes the self-check report to generate diagnostic results of the automobile 10 in response to the diagnostic request. The diagnostic results include one or more items to be selected, each item indicating which components of the automobile 10 needs preventive maintenance or needs to be repaired.

In step S52, the diagnostic server 20 selects one or more of the service stations 30 capable of performing the preventive maintenance or repairs for the automobile 10 according to the diagnostic results.

In step S53, and also referring to FIG. 7, the diagnostic server 20 reads a database 204 for the positional coordinates of the selected service stations 30, calculates the distances between the automobile 10 and each of the selected service stations 30 according to the positional coordinates of the automobile 10 and each of the selected service stations 30, and selects a nearest one of the selected service stations 30 to the automobile 10 as a desirable service station by comparing the distances.

In step S54, the diagnostic server 20 searches the price list of the desirable service station 30 for prices of each item of the diagnostic results. The price list of the desirable service station 30 lists the prices of each maintenance item and each item to be repaired.

In step S55, the diagnostic server 20 combines the prices of each item of the diagnostic results and the positional coordinates of the desirable service station 30 to form an estimate report.

In step S56, the diagnostic server 20 wirelessly transmits the estimate report to the automobile 10 asking the automobile 10 for authorization to start making preparation to perform the preventive maintenance or repairs for the automobile 10.

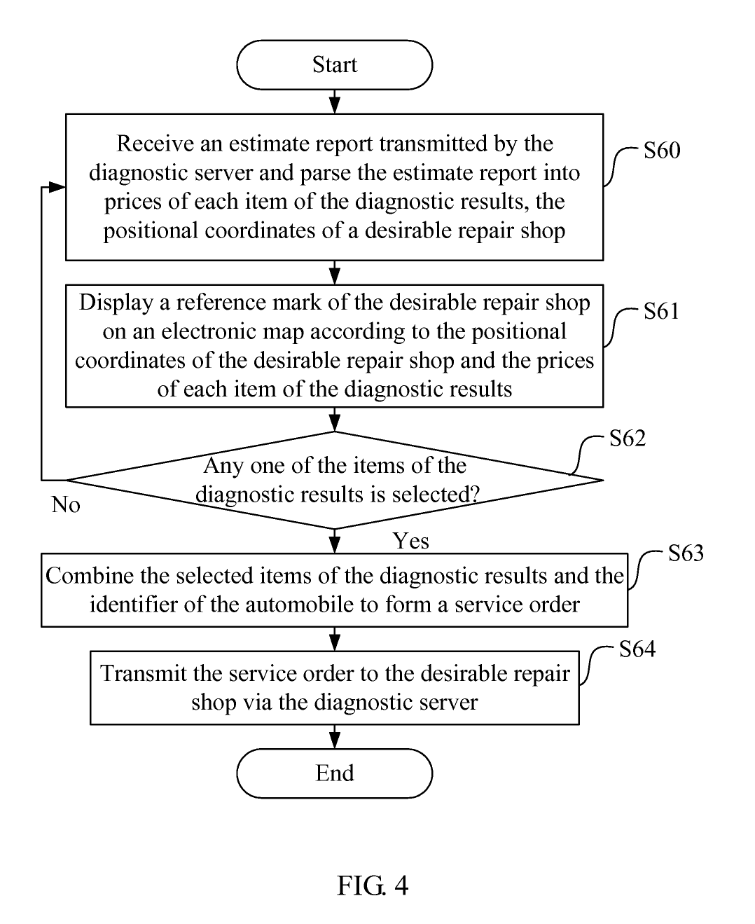

FIG. 4 is an authorizing flowchart of an exemplary method used by the automobile 10 of FIG. 1. In step S60, the automobile 10 wirelessly receives the estimate report transmitted by the diagnostic server 20, and parses the estimate report into the prices of each item of the diagnostic results and the positional coordinates of the desirable service station 30.

In step S61, the automobile 10 displays a reference mark of the desirable service station 30 on an electronic map according to the positional coordinates of the desirable service station 30, and the prices of each item of the diagnostic results. Thereby, a driver of the automobile 10 can decide whether a preventive maintenance or repair is needed, and if needed, further decide to select one or more of the items of the diagnostic results.

In step S62, the automobile 10 detects whether any one of the items of the diagnostic results is selected. If all of the items of the diagnostic results are not selected within a predetermined time, the procedure goes to step S60. If one of the items of the diagnostic results is selected, the procedure goes to step S63.

In step S63, the automobile 10 combines the selected items of the diagnostic results and the unique identifier of the automobile 10 to form a service order. The service order is used for signaling the desirable service station 30 to start making preparation to perform the preventive maintenance or repair.

In step S64, the automobile 10 transmits the service order to the diagnostic server 20, the diagnostic server 20 receives and transmits the service order to the desirable service station 30. Thereby, the desirable service station 30 to start making preparation to perform the preventive maintenance or repair of the automobile 10 in advance. The automobile 10 may be driven to the desirable service station 30 guided by the electronic map. As a result, the automobile 10 can avoid being broken down while traveling.

FIG. 5 is a schematic block diagram of the automobile 10 of FIG. 1. The automobile 10 includes a storage unit 101, a detection unit 102, a signal receiver 104, a diagnostic request unit 106, a vehicle data processing unit 107, a vehicle communication unit 108, a display unit 110, a command input unit 114, and an order generation unit 116.

The command input unit 114 is used for performing input actions of the driver of the automobile 10.

The storage unit 101 stores the unique identifier assigned by the diagnostic server 20.

The detection unit 102 is used for performing the self-check at regular intervals and generates the self-check results.

The signal receiver 104 is used for storing the electronic map, receiving GPS signals at regular intervals, and generating the positional coordinates on the electronic map of the automobile 10 according to the GPS signals.

The diagnostic request unit 106 is used for generating a diagnostic request for signaling the diagnostic server 20 that the diagnostic service is needed for the automobile 10.

The vehicle data processing unit 107 is used for reading the unique identifier of the automobile 10 stored in the storage unit 101, and combining the self-check report, the positional coordinates, and the unique identifier of the automobile 10 with the diagnostic request to form the combined data. The vehicle data processing unit 107 is further used for parsing the estimate report into the prices of each item of the diagnostic results and the positional coordinates of the desirable service station 30.

The vehicle communication unit 108 is used for wirelessly transmitting and receiving signals and data, for example, transmitting the combined data and the diagnostic order to the diagnostic server 20, and receiving the estimate report transmitted by the diagnostic server 20.

The display unit 110 is used for displaying a reference mark of the desirable service station 30 on the electronic map according to the positional coordinates of the desirable service station 30, and the prices of each item of the diagnostic results.

The order generation unit 116 is used for selecting one or more of the items of the diagnostic results via the command input unit 114, and combining the selected items of the diagnostic results and the unique identifier of the automobile 10 to form a service order. The service order is used for signaling the desirable service station 30 to start making preparation to perform the preventive maintenance or repair.

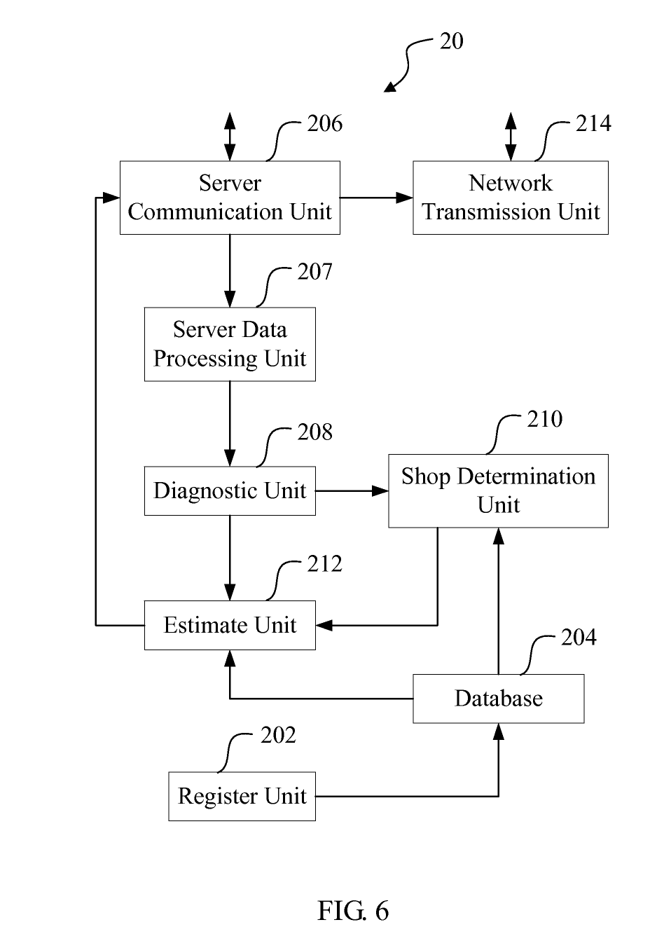

FIG. 6 is a schematic block diagram of the diagnostic server 20 of FIG. 1. The diagnostic server 20 includes a register unit 202, a database 204, a server communication unit 206, a server data processing unit 207, a diagnostic unit 208, shop determination unit 210, an estimate unit 212, and a network transmission unit 214.

The register unit 202 is used for registering the basic information of the automobiles 10 and the service stations 30, and assigning the unique identifier to each automobile 10 for identifying purposes.

The database 204 stores the basic information of the automobiles 10 and the service stations 30. The basic information of the automobiles 10 includes vehicle registration numbers and the vehicle identification numbers (VINs) of each automobile 10. The basic information of the service stations 30 includes a price list, positional coordinates of each service station 30.

The server communication unit 206 is used for wirelessly receiving and transmitting signals and data, for example, receiving the combined data and the service order transmitted by the automobile 10, transmitting the estimate report to the automobile 10, and transmitting the service order to the desirable service station 30.

The server data processing unit 207 is used for parsing the combined data into the diagnostic request, the self-check report, the positional coordinates, and the unique identifier of the automobile 10.

The diagnostic unit 208 is used for analyzing the self-check report to generate the diagnostic results in response to the diagnostic request. The diagnostic results indicate which components of the automobile 10 should be repaired or preventive maintenance performed.

The shop determination unit 210 is used for selecting one or more of the service stations 30 capable of performing the preventive maintenance or repair of the automobile 10 according to the diagnostic results, reading the database 204 for the positional coordinates of the selected service stations 30, calculating distances between the automobile 10 and each of the selected service stations 30 according to the positional coordinates of the automobile 10 and each of the selected service stations 30, and selecting a nearest one of the selected service stations 30 to the automobile 10 as the desirable service station by comparing the distances.

The estimate unit 212 is used for searching the database 204 for the prices of each item of the diagnostic results, combining the prices of each item of the diagnostic results and the positional coordinates of the desirable service station 30 to form the estimate report, and wirelessly transmitting the estimate report to the automobile 10 via the server communication unit 206. The estimate report is used for asking the driver of the automobile 10 for authorization before preparing to perform the preventive maintenance or repair of the automobile 10.

The network transmission unit 214 is used for receiving the service order via the server communication unit 206, and transmitting the service order to the desirable service station 30. Thereby, the desirable service station 30 prepares for performing the preventive maintenance or repair of the automobile 10 in advance. The automobile 10 may be driven to the desirable service station 30 guided by the electronic map. As a result, the automobile 10 can avoid being broken down while traveling.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automobile servicing method, the method comprising:
registering basic information of automobiles and service stations, and assigning a unique identifier to each of the automobiles;
receiving a combined data transmitted by one of the automobiles, and parsing the combined data into a diagnostic request, a self-check report, positional coordinates, and the unique identifier of the automobile;
analyzing the self-check report to generate diagnostic results of the automobile in response to the diagnostic request on condition that the unique identifier being validated;
selecting a desirable one of the service stations capable of performing a preventive maintenance or repair of the automobile according to the diagnostic results and the positional coordinates of the automobile;
searching a price list of the desirable service station for prices of each item of the diagnostic results and positional coordinates of the desirable service station;
combining the prices of each item of the diagnostic results and the positional coordinates of the desirable service station to form an estimate report;
transmitting the estimate report to the automobile, for one or more of the items of the diagnostic results being selected to generate a service order;
receiving the service order transmitted by the automobile; and
transmitting the service order to the desirable service station, for informing the desirable service station to to start making preparation to perform the preventive maintenance or repair of the automobile according to the service order.

2. The automobile servicing method as claimed in claim 1, further comprising:
selecting one or more of the service stations capable of performing the preventive maintenance or repair of the automobile according to the diagnostic results;
reading the positional coordinates of the selected service stations;
calculating distances between the automobile and each of the selected service stations according to the positional coordinates of the automobile and each of the selected service stations; and
selecting a nearest one of the selected service stations to the automobile as the desirable service station by comparing the distances.

3. A diagnostic server comprising:
a register unit for registering basic information of automobiles and service stations, and assigning a unique identifier to each of the automobiles, the basic information including positional coordinates of each of the service stations;
a communication unit for receiving a combined data transmitted by one of the automobiles;
a data processing unit for parsing the combined data into a diagnostic request, a self-check report, positional coordinates, and a unique identifier of the one of the automobiles;
a diagnostic unit for analyzing the self-check report to generate diagnostic results in response to the diagnostic request on condition that the unique identifier of the one of the automobiles being validated, the diagnostic results indicating which components of the automobile need to have preventive maintenance performed or need to be repaired;
a shop determination unit for selecting a desirable one of the service stations capable of performing the preventive maintenance or repair of the one of the automobiles according to the diagnostic results and the positional coordinates of the automobile;
an estimate unit for obtaining prices of each item of the diagnostic results and the positional coordinates of the desirable service station, combining the prices of each item of the diagnostic results and the positional coordinates of the desirable service station to form the estimate report, and transmitting the estimate report to the one of the automobiles via the communication unit; and
a network transmission unit for receiving the service order transmitted by the one of the automobiles via the communication unit, and transmitting the service order to the desirable service station, for informing the desirable service station to prepare for performing the preventive maintenance or repair of the one of the automobiles according to the service order.

4. The diagnostic server as claimed in claim 3, wherein the shop determination unit selects one or more of the service stations capable of performing the preventive maintenance or repair of the one of the automobiles according to the diagnostic results, reads the positional coordinates of the selected service stations, calculates distances between the one of the automobiles and each of the selected service stations according to the positional coordinates of the one of the automobiles and each of the selected service stations, and selects a nearest one of the selected service stations to the one of the automobiles as the desirable service station by comparing the distances.

5. The diagnostic server as claimed in claim 3, wherein the estimate unit searches a price list of the desirable service station for the prices of each item of the diagnostic results.

6. The diagnostic server as claimed in claim 3, further comprising a database for storing the basic information of the automobiles and service stations.

7. An automobile comprising:
a detection unit for performing a self-check at regular intervals, and providing a self-check report;
a signal receiver for receiving GPS signals at regular intervals, and generating positional coordinates of the automobile according to the GPS signals; and
a diagnostic request unit for generating a diagnostic request, the diagnostic request being for signaling a diagnostic server that an estimate report is needed according to the self-check report of the automobile;
a data processing unit for obtaining the unique identifier of the automobile, and combining the self-check report, the positional coordinates, and the unique identifier of the automobile with the diagnostic request to form the combined data; and
a communication unit for transmitting the combined data to the diagnostic server.

8. The automobile as claimed in claim 7, wherein the data processing unit receives the estimate report from the diagnostic server through the communication unit, and parses the estimate report into prices of each item of diagnostic results and positional coordinates of the desirable service station.

9. The automobile as claimed in claim 7, further comprising:
a display unit for displaying a reference mark of the desirable service station on an electronic map according to the positional coordinates of the desirable service station, and the prices of each item of the diagnostic results; and
an order generation unit for selecting one or more of the items of the diagnostic results, combining the selected items of the diagnostic results and the unique identifier of the automobile to form a service order, and transmitting the service order to the diagnostic server via the communication unit, the service order being for requesting a desirable service station to perform the preventive maintenance or repair of the automobile.

10. The automobile as claimed in claim 7, further comprising a storage unit for storing the unique identifier of the automobile.
